(19) United States
(12) Patent Application Publication
(10) Pub. No.: US 2025/0264405 A1
(43) Pub. Date: Aug. 21, 2025

(54) INTEGRATING CAVITY FOR LOW SURFACE GRAVITY APPLICATIONS

(71) Applicant: Southwest Research Institute, San Antonio, TX (US)

(72) Inventors: Kurt D. RETHERFORD, San Antonio, TX (US); Thomas MOORE, San Antonio, TX (US); Charity PHILLIPS-LANDER, San Antonio, TX (US)

(21) Appl. No.: 19/203,487

(22) Filed: May 9, 2025

Related U.S. Application Data
(63) Continuation-in-part of application No. 18/645,967, filed on Apr. 25, 2024, now Pat. No. 12,298,235.
Application No. 18/645,967 is a division of application No. 17/734,830, filed on May 2, 2022, now Pat. No. 11,971,347.
Application No. 17/734,830 is a division of application No. 17/245,987, filed on Apr. 30, 2021, now Pat. No. 11,346,771.

(51) Int. Cl. G01N 21/31; G01N 21/85

(52) U.S. Cl. CPC G01N 21/31; G01N 21/85; G01N 2201/0612; G01N 2201/0636; G01N 2201/08

(57) ABSTRACT

An integrating cavity assembly configured for applicability to optical sample measurements in a low surface gravity environment. The assembly includes features to promote sample delivery and circulation through the internal cavity so that sample positioning, analysis and flushing from the assembly may be practical in such an environment. Once more, the integrating cavity may employ a unique optical scattering monolith of fumed silica that is not only tailored to ultraviolet and visible light but is also seamless for enhanced measurements. The architecture may even present a unique capacity for both sample flushing and re-use without risk of undue damage or deterioration to the fumed silica monolith. Thus, the assembly may be of particular benefit for use and re-use in such a low surface gravity environment.

### BACKGROUND

Materials and items used in a variety of different applications are often evaluated for different character traits prior to use. Samples of different material types may be subjected to tests and evaluations to determine chemical properties, robustness, reflectiveness or any number of different optical and other behaviors. These materials are often tailored for a particular use such as in the case of a reflective coating or an LED material where the evaluating is a matter of quality control and/or setting a rating for the material. However, in many instances, the nature of the material is less tailored or predetermined such as in the case of a geological sample which might be of largely unknown characteristics in advance of any such optical evaluating. This may be the case for core samples of Earth or in a lower surface gravity environment such as attempts to evaluate Moon or Martian soil samples.

When it comes to attaining optical measurements for a sample item, an integrating cavity is often utilized. An integrating cavity, sometimes referred to as an integrating sphere, is an optical apparatus that is defined by a diffuse reflecting material that is used to reflect light in all directions. That is, in contrast to using a mirror to reflect light in a particular direction, an integrating cavity utilizes a cavity of known volume and dimensions that is defined by diffuse reflecting material configured to reflect light from the sample item in all directions, thereby uniformly distributing light within the cavity volume. Thus, more accurate optical characteristics of the sample item may be acquired. The advantage with such an apparatus is that the reflected light may only be lost due to absorption or exit through an opening, but is otherwise unaffected by scattering within the cavity. Optical radiance, spectral response, such as absorption and/or fluorescence, and optical energy may all be measured with a great deal of accuracy by employing an integrated cavity.

One factor in the degree of accuracy attainable by way of integrated cavity measurements is the amount of reflectiveness exhibited by the reflective material. Presently, state of the art integrating cavities may achieve a little over 99% reflectivity, with fairly small losses attributable to absorption. This is due to the availability of diffuse reflective materials such as specially tailored polytetrafluoroethylenes (PTFEs) and other fluoropolymers. However, reflectivity outside of the visible range of between about 400 nm and about 700 nm is diminished with greater amounts of absorption resulting. To this end, for example, where UV light is to be utilized, fumed silica powder has been studied and employed as a suitable reflective Lambertian material. Fumed silica may be an improvement over other more conventional Lambertian materials in that it is known to display reflectivity of over 99.5% in the visible spectral range and even outside of this range, such as in the UV and near infrared spectral range.

Unfortunately, as a practical matter, utilizing fumed silica as a reflective for integrating cavity applications poses significant challenges. More specifically, the behavior of the fumed silica powder is one that is readily prone to degradation as water or other atmospheric contaminants are absorbed by the material during use. Indeed, at present, in spite of the notable improvement in reflectivity, integrating cavities that utilize fumed silica as the reflective have a useful life of no more than about two months. Therefore, integrating cavities lacking this enhanced degree of reflectivity but offering greater durability are still generally utilized in combination with an architecture that presents a seam subject to light path losses.

Another factor in the degree of accuracy attainable by way of utilizing an integrated cavity is the architecture of the cavity device itself. For example, introducing a specimen sample into an integrated cavity may require that some type of hinged opening be utilized to open the housing of the cavity for placement of the sample within the cavity. This means that a seam will be present through the entire device that is prone to present a light path which may affect the accuracy of readings. Furthermore, efforts to evaluate samples on-site in lower surface gravity environments present another architectural challenge in terms of delivering and removing the sample from the cavity device. For example, not only might the seam present an issue but presenting a lunar soil sample to a cavity device at a rover on the surface of the Moon may present challenges. That is, in a more weightless environment, ensuring proper sample delivery to, and removal from, the cavity device presents its own unique challenges. Ultimately, the use of an integrating cavity device to attain accurate integrating cavity sample measurements presents a host of issues of both a reflective material and architectural nature.

### SUMMARY

An integrating cavity device is disclosed. In one embodiment, the device is configured to facilitate optical measurement of a sample in an environment with a surface gravity below that of earth. The device includes an outer housing accommodating a light pipe with an inlet for receiving of the sample. A funnel is coupled to the inlet for guiding of the sample into the housing where a central cavity is located that is defined by a substantially transparent material liner where the sample is received along with light from the light pipe. Further, at least one agitating mechanism is provided at an interface of the funnel and the inlet to facilitate the guiding of the sample to the housing.

### BRIEF DESCRIPTION OF THE DRAWINGS

Implementations of various structures and techniques will hereafter be described with reference to the accompanying drawings. It should be understood, however, that these drawings are illustrative and not meant to limit the scope of claimed embodiments.

FIG. 1 is a side schematic view of an embodiment of an integrating cavity assembly configured for use in a low surface gravity environment.

FIG. 2 is a perspective cross-sectional view of an integrating cavity device of the assembly of FIG. 1.

FIG. 3A is a side schematic view of the assembly of FIG. 1 receiving a sample for acquiring optical measurements therefrom.

FIG. 3B is a side schematic view of the assembly of FIG. 3A advancing the sample to an integrating cavity device of FIG. 2 for the acquiring of the optical measurements.

FIG. 3C is a side schematic view of the assembly of FIG. 3B flushing the sample from the device.

FIG. 4 is a side overview of a rover accommodating the assembly of FIG. 1 and employed in a low surface gravity environment.

FIG. 5A is a side cross-sectional view of an embodiment of a seamless fumed silica integrating cavity device.

FIG. 5B is an enlarged view taken from 5-5 of FIG. 5A illustrating light behavior during a measurement test run with the integrating cavity device.

FIG. 6 is a flow-chart summarizing an embodiment of utilizing the assembly of FIG. 5 to attain optical measurements of a sample in a low surface gravity environment.

### DETAILED DESCRIPTION

Embodiments are described with reference to a particular seamless integrated cavity assembly utilizing fumed silica as a diffuse reflective material. Specifically, the embodiments depict an assembly for use in a particular low surface gravity environment such as the Earth's moon. However, any number of low surface gravity environments, including wholly extra planetary environments, may be pertinent to the embodiments described herein. Further, features such as fumed silica materials or a seamless character may be employed, though not required. Similarly, the nature of sample flow promoting mechanisms such as a funnel or agitators may be varied in terms of implementation and/or architecture. Regardless, so long as the assembly includes a funneled inlet to a cavity device along with an agitator to promote sample flowing in such an environment, appreciable benefit may be realized.

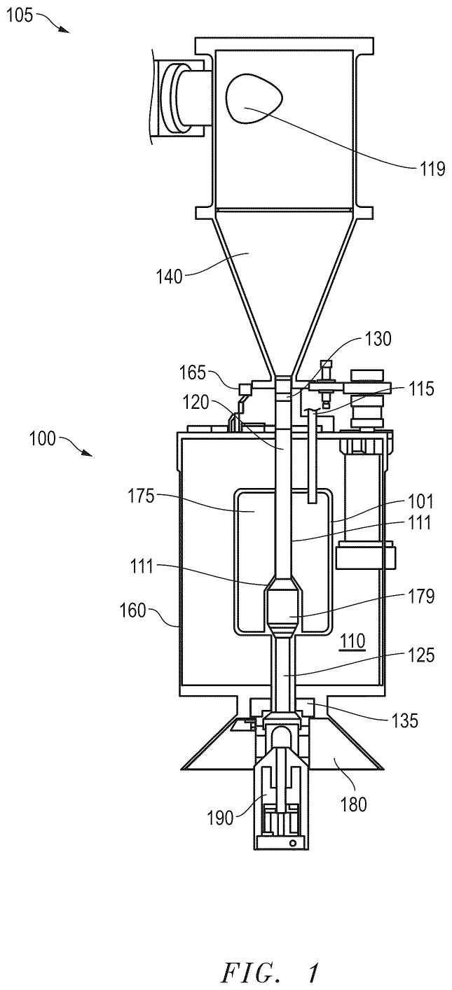

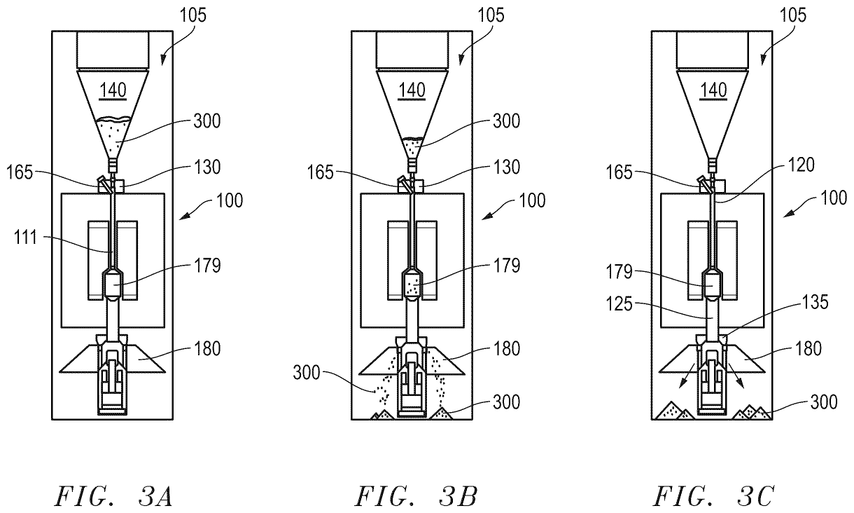

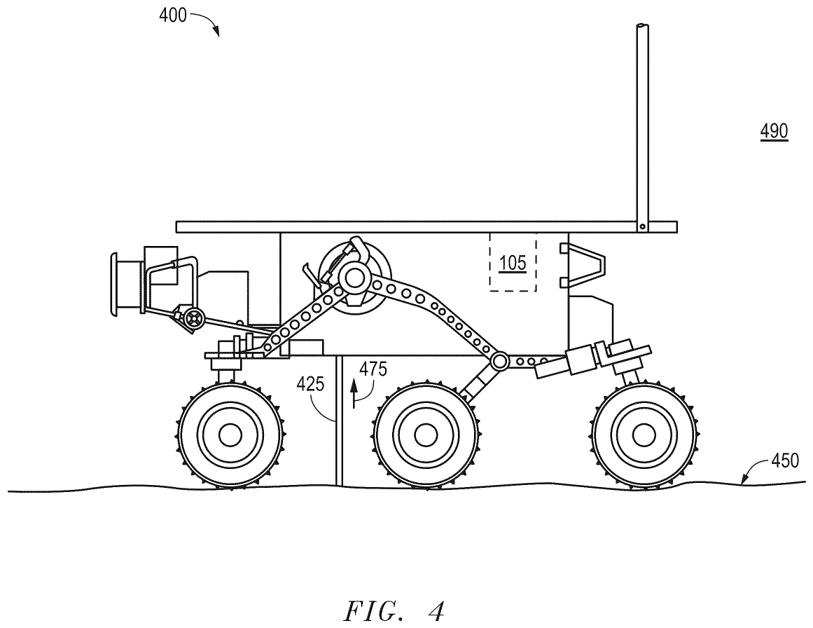

Referring now to FIG. 1, a side schematic view of an embodiment of an integrating cavity assembly 105 is shown. The assembly 105 is configured for use in a low surface gravity environment. For example, the assembly 105 may be incorporated into a rover 400 at a lunar surface 450 as illustrated in FIG. 4. Regardless, with added reference to FIGS. 3A-3C, the assembly 105 includes an integrating cavity device 100 that is constructed to facilitate the acquisition of optical measurements from a sample 300 that is delivered to the assembly 105. Notably, given the potential low surface gravity environment in play, the assembly 105 is shown with a funnel 140 for guiding a sample 300 toward the integrating cavity device 100. Additionally, an inlet agitator 130 may be provided to induce a vibration at an interface between the funnel 140 and an inlet 120 leading to, and/or through, a cavity 175 of the device 100 from where sample measurements are to be acquired. Similarly, an outlet agitator 135 may be provided to induce a vibration at an interface between an outlet 125 and a flared exit 180 leading from the device 100. Thus, circulation of the sample 300 into and out of the device 100 may be promoted even in a low surface gravity environment.

Continuing with reference to FIGS. 1 and 3A-3C, the agitators 130, 135 may be of a conventional piezoelectric variety tuned to operate at predetermined frequency ranges. For example, a channel 111 for receiving the sample 300 may include the noted inlet 120 and outlet 125 along with an enlarged central profile 179, all made up of a transparent material such as a fused silica or quartz. Thus, the predetermined operation frequencies for the piezoelectric agitators may be tuned to ranges that are safe for the integrity of the selected transparent material.

For the embodiment shown, the integrating cavity assembly 105 is also equipped with a gas manifold 165 to provide for the influx of gas toward the inlet 120. So, for example, an inert gas may be directed toward the channel 111 for circulating of the sample 300 through the device 100. This may be particularly helpful during flushing of the sample 300 from the central profile 179 and through the outlet 125. The gas utilized may be nitrogen, argon or other suitably inert option, selected to avoid reactivity with the sample or air introduced during sample delivery. Further, notice that the exit 180 is flared to help facilitate sample purging or control distribution away from the device 100 upon flushing as described. That is, once sample measurements have been acquired and sample removal is at hand, employing the architecture of a flared exit 180 may help avoid any undesirable constriction which might impede sample flushing from the device 100.

Continuing with reference to FIG. 1, additional features of the assembly 105 and device 100, which are described in further detail below, are also illustrated. Specifically, the operation of the integrating cavity device 100 is based on the introduction of light to a cavity 175 where the sample 300 shown in FIG. 3B is held at a central profile 179 as indicated. This is shown provided by a light pipe 115. As detailed further below, the particular device 100 embodiment shown is seamless and employs a fumed silica monolith 110 about the cavity 175. Once more, the channel 111 which includes the profile 179 and a liner 101 which define the cavity 175 are of a transparent material such as fused silica. Further, a coil stopper 190 is shown that may be utilized to provide for isolation of the channel 111 during testing or, alternatively, to be opened to allow for sample flushing as described. These particular architectural features may be of benefit for use with ultraviolet light and for various other conditions as detailed below. However, alternative architectures, features and material options may be suitable for use in the described low surface gravity environment described.

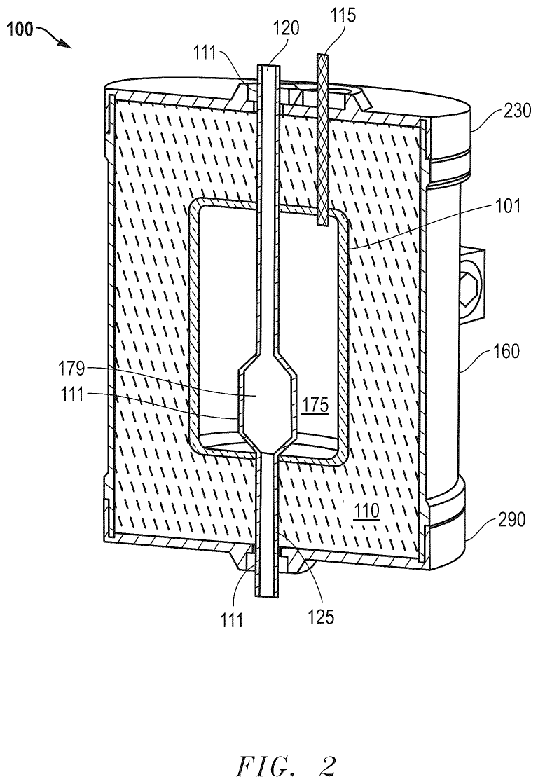

Referring now to FIG. 2, a perspective cross-sectional view of the integrating cavity device of the assembly 105 of FIG. 1 is shown. This particular embodiment may be beneficial for attaining measurements where ultraviolet light is to be employed. Furthermore, this is achieved in a manner that is reliably repeatable due to the underlying fumed silica monolith 110 that is employed along with a protective architecture that includes a unique liner 101 and channel 111 manner of sample isolation within the depicted cavity 175. While this particular architecture may be beneficial for low surface gravity applications, other architectural options may also be employed.

Continuing with reference to FIG. 2, the seamless fumed silica integrating cavity device 100 is provided in a package form for ease of transport and installation with user friendly mounting hardware provided. It is also apparent that this embodiment is well suited for flowing a sample of a gas, liquid, granular materials or other substance into the inlet 120 (e.g. the sample 300 of FIGS. 3A-3C). The sample 300 is ultimately circulated out the outlet 125 with readings taking place over the interim. Of course, a powder, soil or other type of substance may be introduced to the cavity 175 for measurement by way of the channel 111 so long as the specimen type is suitably small enough relative the dimensions of the device 100 and channel 111.

Continuing with reference to FIG. 2, in one embodiment, the specimen or sample may be supplied to the cavity 175 for measurement in more of a static rather than flowing manner. Whether held statically or continuously flowed, the movement of the specimen into and out of the cavity 175 may be aided by employment of the gas manifold 165 as described herein.

In FIG. 2, the sandwiching of the monolith 110 of fumed silica between the liner 101 and housing structure 160 is structural. This sandwiching of the monolithic fumed silica 110 may help avoid damage due to impact or vibration that might be found in an industrial environment whether in a low surface gravity environment or otherwise. Therefore, the integrating cavity 100 may be used in a harsher environment or even shipped, by land, sea, air, rocket or whatever the case may be, without undue concern over damage.

The monolithic fumed silica 110 may be fabricated as a monolithic structure of packed 20-50 nm particle size fumed silica. Pressurizing and baking of the fumed silica 110 in conjunction with the pressing or packing, for example, at 800-1,000° C., may be used to eliminate moisture prior to monolithic fabrication by way of an additive process. Thus, as illustrated, the fumed silica 110 may be provided over the lower end cap 290, layer by layer, with repeated pressing or packing in order to form a complete monolith 110 around the liner 101 until complete as illustrated with the upper end cap 230 then completing the device 100. For such an embodiment, this means that reductive machining or milling to remove monolithic material may be avoided in forming the cavity. Thus, monolithic material losses of up to 60% for a 10″ cavity may be avoided.

For such an embodiment, there would be no internal gaps or seams and each monolith would be environmentally isolated by the indicated sandwiching. Further, as indicated above, the final construct may be under a vacuum seal, for example by a conventional low outgassing adhesive isolating process, ultimately enhancing reflectivity of the monolith 110. Electrostatic forces of the fumed silica particles may act to further hold each monolith 110 together. Ultimately, a diffuse reflective with a reflectivity of over 99.8% in the visible spectral range of 400 nm-700 nm may be attained that is held together in a mechanically resilient and reliable form. Even outside of this range, reflectivity of greater than about 99.5% may extend from about 220 nm to about 1,300 nm for such fumed silica embodiments. By the same token, the light pipe 115 and channel 111 structures of FIGS. 1 and 2 would likely already be incorporated into and/or interfacing with the liner 101 in advance of the illustrated construction of the monolith 110.

Referring now to FIGS. 3A-3C, side schematic views of the integrating cavity assembly 105 are shown employed from delivering a material sample 300, advancing the sample for measurement and completed flushing of the sample 300 from the assembly 105. With specific reference to FIG. 3A, the sample is shown placed at the funnel 140 for delivery to the integrating cavity device 100 from where optical measurements may be obtained. Given the potentially low surface gravity environment, the inlet agitator 130 may be utilized to introduce a vibration to help facilitate movement of the sample 300 from the funnel 140 toward the central profile 179 of the channel 111.

Referring now to FIG. 3B a side schematic view of the assembly 105 of FIG. 3A is shown with the advancing sample 300 having reached the central profile 179 for optical measurement acquisition. Indeed, the particular depiction shown may be just after optical measurement taking relative the sample 300 with the coil stopper 190 no longer isolating the channel 111. Thus, even unaided, a certain limited amount of the sample 300 may begin to leave the integrating cavity device 100 and assembly 105.

However, with specific reference to FIG. 3C a substantially completed flushing of the sample 300 from the device 100 is illustrated. This may be promoted by the outlet agitator 135, perhaps in the form of a piezoelectric resonator mechanism to induce vibration. However, also recall that a gas manifold 165 may be utilized to direct air at the channel 111 to promote sample removal as illustrated. In the embodiment shown, an air line from the manifold 165 may intersect the channel 111 near the inlet 120 at about 45°. Indeed, an angle of intersect that is less than 90° may be of most benefit for delivery of an effective gas delivery or puff for circulating sample 300 as described. Further, the architecture at the end of the outlet 125 includes the structure of a flared exit 180 to prevent a wider distribution of the gas blown sample 300 away from the outlet 125 to discourage any impacts by the sample on nearby items. Ultimately, the interior of the channel 111 may be sufficiently cleared of sample debris in this manner so as to allow for subsequent testing of a different sample material.

Referring now to FIG. 4, a side overview of a rover 400 accommodating the assembly 105 of FIG. 1 is shown. Of course, other types of surface or extra planetary equipment may accommodate the assembly 105 as well. Regardless, the illustrated rover 400 is positioned in a low surface gravity environment 490 such as at a lunar surface 450. Surface regolith materials on such planetary bodies are often sought for evaluation of different character traits such as the presence of water related indicators or potential exposures thereto. Further, testing of surface materials on-site may be preferable to the requirement of first transporting samples via space flight back to Earth.

Continuing with reference to FIG. 4, a sample acquisition mechanism 425 is shown extended from the rover 400. This may be a conventional coring device, arm, or any number of tools tailored to bring sample up to the rover (see arrow 475). Similarly, with added reference to FIGS. 3A-3C, routing of the sample 300 over to the integrating cavity assembly 105 within the rover 400 may be achieved through any number of conventional conveyance mechanisms, whether a conveyor belt or more sophisticated manner of advancement. Thus, delivery, testing and flushing of samples 300 as detailed hereinabove may proceed at the integrating cavity assembly 105.

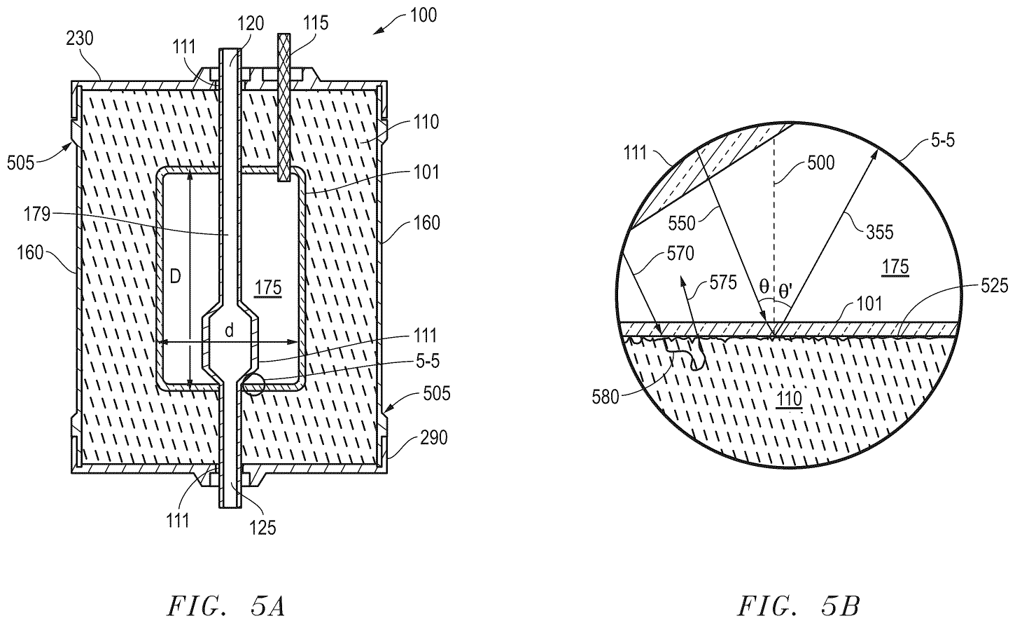

Referring now to FIGS. 5A and 5B, a particular embodiment of integrating cavity device 100 that may be utilized in obtaining optical measurements is described in greater detail. Specifically, FIG. 5A illustrates a side cross-sectional view of an embodiment of a seamless fumed silica integrating cavity device 100 whereas FIG. 5B is an enlarged view taken from 5-5 of FIG. 5A, illustrating light behavior during a measurement test run with the integrating cavity device 100.

Continuing specifically with reference to FIG. 5A, the device 100 is largely comprised of a fumed silica 110 to serve as a diffuse reflective about the cavity 175. However, in other embodiments, magnesium fluoride or barium sulfate may be utilized as the monolith 110 detailed herein. The housing 505 is seamless with an outer body 160 that is capped at each end with an upper 230 and lower 290 end caps that may be threaded, welded or otherwise fusibly secured to the body 160. The body 160 and end caps 230, 290 may be comprised of a suitable material such as stainless steel or titanium, although other durable materials may be utilized to supply adequate hardware for securing the cavity as described herein. Regardless, the interior defined by the outer body 160 and end caps 130, 190 is filled with the fumed silica 110 in a tightly packed monolithic form. As alluded to above and detailed further below, this type of fumed silica 110 may be highly effective as a diffuse reflective for integrating cavity applications such as optical spectroscopy or routine optical photometry and metrology.

Continuing with reference to FIG. 5A, to enhance the long-term reliability and effectiveness of the fumed silica 110 as a diffuse reflective, a substantially transparent liner 101 is provided at the inner surface of the monolithic silica 110. In the embodiment shown, an interior flow-through cell or channel 111 is also provided through the device 100, including through the monolith 110 and the cavity 175. Thus, an inlet 120 and outlet 125 may be provided for flowing a sample into and out of the cavity 175 as described further below. The channel 111 may be of the same material as the liner 101 with a 40 thread per inch or other suitable mounting feature where intersecting the end caps 230, 290. In the embodiment shown, the channel 111 includes a central profile 179 that is larger in diameter than the inlet 120 and outlet 125. However, in other embodiments, the profile 179 may be avoided with the inlet 120 and outlet 125 meeting in an integral manner with the liner 101 defining the cavity 175.

Among other benefits, the liner 101, or the channel 111 where present, provides a clear durable surface that may be cleaned using common solvents and cleansers without long-term effects to the liner 101 or channel 111 structure. However, as described, gas alone, along with agitation, may be introduced for cleaning where measurements are to take place in a low surface gravity environment. With added reference to FIGS. 3A-3C, the inner surface of the silica 110 defines the actual cavity 175 of the integrating cavity device 100. A sample 300 for evaluation may be flowed through the cavity 175 for evaluation, with or without the aid of the channel 111 and profile 179 as described above. Thus, the ability of the silica 110 to serve as a diffuse reflective with respect to the cavity 175 and sample 300 therein is dependent on the transparent nature of the liner 101 and channel 111 materials. In one embodiment, these materials are of a fused quartz, which may be referred to as a “fused silica” (see above). In one embodiment, the liner 101 and/or channel 111 are of a clarity that displays negligible effect on light directed from the cavity 175 interior toward the fumed silica 110 or that is diffusely reflected back from the fumed silica 110. Thus, the liner and channel materials may be referred to herein as being “substantially transparent”. This term is meant to encompass any degree of substantial translucency, such as where the is intentionally frosted or tailored with a degree of opaqueness or color additive to attain a degree of light filtering for sake of measurement focus.

The noted light of the cavity 175 during an integrating cavity application is provided and diffusely reflected back relative a round, square, rectangular, tapered or hexagonal rod of a light pipe 115. This pipe 115 may be a collimated integrating or homogenizing light pipe constructed of the same fused quartz or other material of the liner 101 and channel 111. The pipe 115 may interface with fiber optics for sake of light delivery and collection relative the cavity 175. The dimensions of the cavity 175 (such as (D) and (d), perhaps 2-4 inches each) are stored such that absorption and other readings acquired from an integrating cavity application as they relate to a given sample 300 may be used to calculate optical characteristics thereof.

The light pipe 115 may interface the liner 101 in an air-tight manner and serve to sealingly define the cavity 175 with respect to the contained fumed silica 110. Given the irregular morphology and potentially structurally delicate nature of the packed fumed silica 110, the liner 101 specifically may also serve a function of mechanical reinforcement to the underlying monolithic silica 110. In one embodiment, the liner 101 is not only air-tight but also placed under vacuum to even further enhance structural integrity and reflectiveness of the silica 110 as described below. Once more, this may serve as an added degree of isolation where high pressures are introduced through the channel 111 or cavity 175 during sample introduction or flowing. Indeed, from a differential standpoint, this is likely to be the case in a low surface gravity environment as described herein.

Notice the sandwiching of the monolith 110 of fumed silica between the liner 101 and housing structure 160 (and/or 290, 230) as shown in FIG. 5A. This sandwiching of the monolithic fumed silica 110 may help avoid damage due to impact or vibration that might be found in an industrial environment. Therefore, the integrating cavity 100 may be used in a harsher low surface gravity environment as described as well as durably endure the spaceflight to the environment, without undue concern over damage.

Referring now to FIG. 5B, an enlarged view taken from 5-5 of FIG. 5A is shown illustrating light behavior during a measurement test run within the device 100. More specifically, this view illustrates the behavior of light (e.g. 550, 555, 570, 575) during a measurement test run with the integrating cavity 100 of FIG. 5A. Notice the highly irregular surface 525 of the fumed silica 110. The illustration highlights the irregular morphology of fumed silica particles but is not meant to infer that there would be any notable spaces between the compacted monolithic fumed silica 110 and the depicted liner 101. Rather, the illustration highlights the fact that the diffuse reflective of fumed silica 110 may scatter light 550, 570 in every manner of directions. For example, like a conventional non-diffuse reflective, the fumed silica 110 may receive incident light 550 at one angle θ and reflect it 555 at another roughly equivalent angle θ′ (as measured along a perpendicular axis 500 relative the surface 525). This mirroring of the light 550, 555 would be fairly standard for a non-diffuse reflective material. However, the unique nature of the fumed silica 110 is that it is highly diffuse with a substantially irregular surface 525 and morphology throughout. Thus, in other instances, incident light 570 may be received, penetrate the surface 525 by several mm, bounce around in a refracted nature within the material (see 580) and ultimately be reflected 575 at any number of different angles irrespective of the angle of the received incident light 570. That is, while the light 570 may initially seem to be absorbed, it will generally end up reflected 575 but at a random angle having no apparent relation to the angle of the incident light 570.

Continuing with reference to FIG. 5B, the refracted bounced around light 580 penetrating the fumed silica 110 is generally ultimately reflected as illustrated. Indeed, the fumed silica 110 may be rated to be over 99.8% reflective as indicated, filling the volume of the cavity 175 with light. Thus, only negligible degree of absorption of the light 570 actually occurs. Further, the randomness with which the light is reflected results in a Lambertian scattering of light displaying a radiance that is the same in all directions which is well suited for integrated cavity applications. For example, a sample 300 that is flowingly directed through the channel 111 may be analyzed in terms of its own differing effect on light and absorption in contrast to the scattered light (see FIGS. 3A-3C). So, for example, a powder amino acid may be flowed through and subjected to such an application to ascertain its characteristics, purity or even to confirm that the amino acid is the purported amino acid sample in advance of device use. Any number of other substances may be evaluated in much the same way.

Due to the transparent nature of the liner 101 and channel 111 structures, all of this diffuse reflective behavior of the light is substantially unaffected by the structures. Further, these structures 101, 111 provide a more durable interface for the environment that is receptive to cleaning as described above. Therefore, the integrated cavity 100 is not only effective as an optical measurement device, but it may be repeatedly used over time, with measurements of one sample followed by measurements of another, without undue concern over device durability.

Optical sample detections may be analyzed in various manners. Depending on the application to be run, this may be referred to as an iCAS (integrated cavity absorption spectroscopy), iCRD (integrating cavity ring-down spectroscopy), iCEFS (integrating cavity enhanced fluorescence spectroscopy), ICERS (integrating cavity enhanced Raman spectroscopy) or other application system. The integrating cavity 100 may be employed in conjunction with a laser assembly and a spectrometer to deliver light and collect light, respectively for analysis, perhaps as part of a system located at the rover 400 of FIG. 4. Of course, any spectral detector may be suitably employed. Further, a conventional laptop remotely and communicatively coupled to the spectrometer may serve as an interface for analysis of the collected light data from the spectrometer. Ultimately, this may provide optical information regarding the flowing sample to and from the cavity in real-time even in a low surface gravity environment.

Continuing with reference to FIG. 5A, a laser assembly or other light source may emit light from a diode laser along a laser optical fiber to the integrating cavity 100 via an optical coupling at the depicted light pipe 115. In one embodiment, the coupling is a common lens mount thread to support fiber optic connectivity. Regardless, the resultant scattered light as described above may be collected through the optical fiber via the same coupling and pipe 115 for routing to the associated spectrometer. Because light uniformly fills the cavity 175, the whole sample surface or volume within the cavity is measured simultaneously providing enhanced sample measurements for analysis. As suggested, the particular application may vary. For example, in one embodiment “ring-down” characteristic time of short light pulses interacting with the sample 300 may be analyzed. Of course, Raman or trace fluorescence measurements may also be analyzed or any number of readings evaluated. These may also include metrology analyses such as radiance, emission spectral energy or even power measurements.

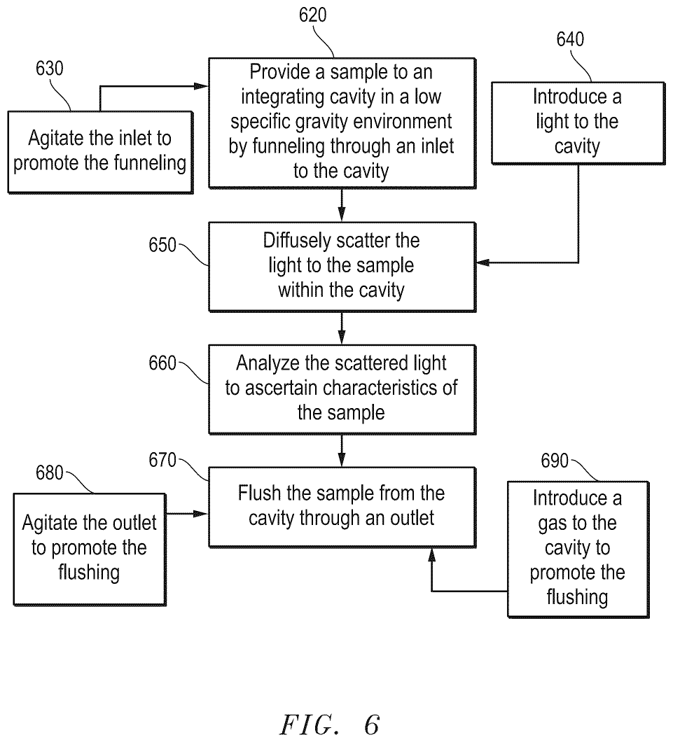

Referring now to FIG. 6, a flow-chart summarizing an embodiment of utilizing an integrating cavity assembly in a low surface gravity environment is illustrated. Specifically, a sample is provided to the assembly in a manner that funnels the sample to a cavity of the assembly as indicated at 620. To promote the advancement of the sample to the cavity, an inlet to the cavity may be agitated as noted at 630, for example, with a piezoelectric mechanism. Once the sample has reached the cavity, light may be introduced (see 640) and diffusely scattered to the sample and throughout the cavity (see 650).

As with other integrating cavities, the scattered light may be analyzed to ascertain characteristics of the sample as indicated at 660. However, removing or flushing of the sample from the cavity after this data collection and/or analysis as noted at 670 may be furthered by additional features of the assembly. For example, an outlet from the cavity may be agitated as indicated at 680 and a gas may be introduced to the cavity as indicated at 690 to further promote the flushing. So, for example, another sample may be introduced to the cavity and the process repeated.

Embodiments described hereinabove include integrating cavities with added features for enhanced utility in low surface gravity environments. These cavity devices may include various features to manage circulation into and out of the cavity in the face of such low surface gravity environments. Once more, seamless architecture utilizing a fumed silica monolith may be employed that includes include a protective lining at the surface of the fumed silica that is transparent and protective to the underlying fumed silica while simultaneously supporting flowing, dynamic sample analysis. This means that even in the more challenging environment, the devices may be cleaned and utilized repeatedly without undue concern over impurities in the cavity or damage to the fumed silica that might render the devices less effective. Indeed, agitation and air may be sufficient to achieve cleaning for sake of on-site re-use.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. An integrating cavity assembly to facilitate optical measurement of a sample in an environment having a surface gravity below that of earth, the assembly comprising:
an outer housing accommodating a light pipe and an inlet for receiving of the sample;
a funnel coupled to the inlet for guiding of the sample to the housing;
a central cavity defined by a substantially transparent material liner to receive the sample from the inlet and light from the light pipe; and
at least one agitating mechanism at an interface of the funnel and the inlet to facilitate the guiding of the sample to the housing.

2. The integrating cavity assembly of claim 1 further comprising a gas delivery manifold coupled to the interface of the funnel and the inlet to facilitate flushing of the sample from the assembly after the optical measurement.

3. The integrating cavity assembly of claim 2 further comprising another agitating mechanism coupled to an outlet of the assembly to facilitate the flushing of the sample from the assembly.

4. The integrating cavity assembly of claim 3 wherein the agitating mechanisms are piezoelectric.

5. The integrating cavity assembly of claim 3 further comprising a flared exit coupled to the outlet to control sample distribution away from the assembly upon the flushing.

6. The integrating cavity assembly of claim 3 further comprising a coil stopper coupled to the outlet to govern isolation and circulation of the sample within the assembly.

7. The integrating cavity assembly of claim 3 further comprising a liner defining a cavity within the assembly and coupled to the inlet and the outlet, the liner comprised of one of fused silica and quartz.

8. The integrating cavity assembly of claim 7 further comprising a channel through a cavity defining the inlet and the outlet that is comprised of one of fused silica and quartz.

9. The integrating cavity assembly of claim 7 wherein the light is ultraviolet and the liner provides a barrier between the cavity and a fused silica monolith for scattering of the light for the optical measurement of the sample.

10. The integrating cavity assembly of claim 1 wherein the assembly is accommodated by equipment that is one of surface equipment and extra planetary equipment.

11. The integrating cavity assembly of claim 10 wherein the equipment is the surface equipment and the sample is a regolith sample.

12. A method of obtaining optical measurements of a sample in an environment having a surface gravity below that of earth, the method comprising:
funneling the sample to a cavity through an inlet of an integrating cavity device;
agitating the inlet to promote the funneling;
introducing a light to the cavity;
diffusely scattering the light to the sample within the cavity to facilitate the obtaining of the optical measurements; and
flushing the sample from the cavity through an outlet.

13. The method of claim 12 wherein the flushing is promoted by one of:
agitating the outlet; and
introducing a gas to the cavity.

14. The method of claim 12 further comprising:
employing a stopper for isolating the sample within the cavity during the obtaining of the optical measurements;
opening the stopper to cease the isolating; and
releasing the sample from the cavity over a flared exit from the outlet during the flushing to control sample distribution away from the assembly.

15. A method of acquiring optical characteristics from a sample item with a measurement system having a seamless integrating cavity device, the method comprising:
flowing the sample through a cavity of the device from an external location;
projecting a light toward the cavity, the cavity defined by a fumed silica monolith;
utilizing the fumed silica monolith to diffusely scatter the light across a transparent liner positioned over the monolith;
acquiring the scattered light from the cavity; and
analyzing the acquired light to ascertain the optical characteristics of the sample item.

16. The method of claim 15 wherein the sample item is provided as one of a gas, liquid, powder and granular material form.

17. The method of claim 15 further comprising:
imparting an air-tight vacuum pressure on the monolith supported by the transparent liner; and
subjecting the device to a vibration condition during one of transport and use in an industrial environment.

18. The method of claim 15 wherein the flowing of the sample comprises closing a valve at the cavity to temporarily hold the sample during the acquiring of the scattered light.

19. The method of claim 15 further comprising:
cleaning one of the cavity at the liner and a channel through the device; and
re-flowing another sample through the device for another analyzing.

20. The method of claim 15 further comprising, fabricating the fumed silica monolith in an additive fashion about the liner in a manner comprising:
packing a structure of fumed silica particles ranging from about 20 nm to about 50 nm in particle size into a monolith, layer by layer; and
baking the monolith under pressure at between about 800° C. and about 1,000° C.
